(19) United States
(12) Patent Application Publication
(10) Pub. No.: US 2018/0199169 A1
(43) Pub. Date: Jul. 12, 2018

(54) MOBILE PHONE MAPPED LANDLINE BASED CALL INITIATION

(71) Applicant: Vishal Gupta, Delhi (IN)

(72) Inventor: Vishal Gupta, Delhi (IN)

(21) Appl. No.: 15/580,693

(22) PCT Filed: Jun. 10, 2016
(86) PCT No.: PCT/IB2016/053422

§ 371 Date: Dec. 8, 2017

(30) Foreign Application Priority Data
Jun. 10, 2015 (IN) 1748/DEL/2015

(51) Int. Cl. H04W 4/16; H04M 3/42

(52) U.S. Cl. CPC H04W 4/16; H04M 3/42263; H04M 3/42059; H04Q 2213/13097; H04Q 2213/13098; H04M 2203/2094; H04M 2203/1091

(57) ABSTRACT

The present disclosure relates to a system for initiating a call from a landline that is mapped to a caller mobile phone, wherein system includes a call request receipt module configured to, at a first computing device, receive, from the caller mobile phone, a call request comprising a caller identifier and a callee phone number; a landline determination module configured to, at the first computing device, determine the landline based on the received caller identifier, a landline based call initiation module configured to, using the first computing device, initiate a first call to landline number of the determined landline; a callee call initiation module configured to, using the first computing device, initiate a second call to callee phone number; and a callee connection module configured to conference the first call with the second call.

### TECHNICAL FIELD

The present disclosure relates to the field of telecommunication. More particularly, the present disclosure relates to systems and methods for establishing phone calls between a caller and callee.

### BACKGROUND

Background description includes information that may be useful in understanding the present invention. It is not an admission that any of the information provided herein is prior art or relevant to the presently claimed invention, or that any publication specifically or implicitly referenced is prior art.

Telecommunication systems have become integral part of our life today. Early developments of telecommunication systems were limited to wired communications, for example public switched telephone network (PSTN) wired connections, which have some of their own limitations. Making a calling or receiving a call using landline phone is not very convenient as the landline phone limits movement of user. User of landline phone also faces problem while making a call, as he/she needs to dial each digit of a telephone number individually, which may be time consuming and sometimes may cause dialing of a wrong number. On the other hand, advent of mobile phones has provided flexibility to user to make calls from anywhere and also the convenience of dialing a number saved in contact list. Although landline phones using PSTN have certain limitations. PSTN connections are still being used widely as PSTN connections provide clear voice quality and enable low cost of communication. Many users prefer to maintain both the landline phone and the mobile phone.

In certain scenarios, a user may want to dial a number that is saved in contact list of mobile phone through PSTN connection. To do so, the user may have to browse contact details in mobile phone and then dial the number manually through landline phone. User needs to dial each digit of the number individually and therefore calling through PSTN is not very convenient. User may want to dial through landline phone as cost of call through PSTN connection may be less than cost of call through mobile network. The user may want to dial through PSTN in several other scenarios, for example when mobile phone network is not available, or the mobile phone network is weak, or when user does not have balance in his/her account associated with the mobile phone.

Therefore, there is a need for a system and method that can enable making of calls from landline (PSTN connection) using advantages provided by a mobile phone.

In some embodiments, the numerical parameters set forth in the written description and attached claims are approximations that can vary depending upon the desired properties sought to be obtained by a particular embodiment.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Marcus groups used in the appended claims.

### Objects of Invention

An object of present invention is to provide a system and a method that can enable making of a call through PSTN by dialing a number over a mobile phone.

An object of present invention is to provide a server/cloud based service that enables mapping of landline phone numbers with mobile phone numbers such that calls initiated from mobile phones can be dialed through mapped landline phone numbers.

An object of the present invention is to provide a system and a method that can enable call through PSTN line by dialing a number saved in contact list of a mobile phone.

An object of the present invention is to provide a method for enabling routing of call initiated by a mobile phone through PSTN.

An object of the present invention is to provide an adaptor that is configured between PSTN line and a landline phone, wherein the adapter can receive sound signals from a mobile phone when the mobile phone dials a callee, and can forward the callee number received in the sound signals to the landline phone such that the landline phone can initiate the call.

### SUMMARY

The present disclosure relates to the field of telecommunication. More particularly, the present disclosure relates to systems and methods for establishing phone calls between a caller and callee.

In an aspect the present disclosure relates to a system for initiating a call from a landline that is mapped to a caller mobile phone, wherein system includes a call request receipt module configured to, at a first computing device, receive, from the caller mobile phone, a call request comprising a caller identifier and a callee phone number; a landline determination module configured to, at the first computing device, determine the landline based on the received caller identifier; a landline based call initiation module configured to, using the first computing device, initiate a first call to landline number of the determined landline; a callee call initiation module configured to, using the first computing device, initiate a second call to callee phone number, and a callee connection module configured to conference the first call with the second call.

In an aspect, the caller identifier can be any or a combination of a unique identifier of the caller, or caller's mobile number.

In another aspect, the call request can further include any or a combination of a location context of the caller, preferred landline to be used, or selection of a landline from a plurality of landlines stored at the first computing device. In an aspect, the location context of the caller can include any geographical feature. In an aspect, geographical feature can be determined based on any or a combination of NFC (Near-Field Communication), GPS (Global Positioning System), Wi-Fi, radio signals, sound signals, optical signals, and Bluetooth.

In an aspect, the first computing device can be coupled with a database that stores mapping between the caller identifier and the landline. In an aspect, the database can further store mapping between the caller identifier and a plurality of landlines, wherein the landline can be selected from the plurality of landlines based on location context of the caller or preference defined by the caller. In an aspect, the landline can be mapped with a plurality of caller identifiers.

In another aspect, the caller can be enabled to modify or add or delete or change preference of one or more landlines that map with the caller identifier.

Furthermore, the call request can be initiated from the caller mobile phone to the first computing device by means of any or a combination of a call, an SMS, an application (such as a mobile application), a signal, a data packet, or selection of the callee on a contact directory.

In another aspect, the second call can be initiated before the first call, or both the calls can be initiated simultaneously.

The present disclosure further relates to a method of initiating a call from a landline that is mapped to a caller mobile phone, wherein the method can include the steps of receiving, at a first computing device, from the caller mobile phone, a call request comprising a caller identifier and a callee phone number; determining, at the first computing device, the landline based on the received caller identifier; initiating, using the first computing device, a first call to landline number of the determined landline; initiating, using the first computing device, a second call to callee phone number, and conferencing the first call with the second call.

The subject matter described in this specification can be implemented in particular embodiments so as to realize one or more of the following advantages. The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary architecture that can be used for enabling a call initiated on a mobile phone to take place over a PSTN line in accordance with an embodiment of the present disclosure.

FIG. 2 illustrates exemplary functional modules of a system for enabling call over a mobile phone through PSTN line in accordance with an embodiment of the present disclosure.

FIG. 3 illustrates an exemplary network set-up for enabling call initiated by a mobile phone to take place over a PSTN in accordance with an embodiment of the present disclosure.

FIG. 4 illustrates an exemplary call routing through a landline phone for a call initiated by a mobile phone in accordance with an embodiment of the present disclosure.

FIG. 5 illustrates an exemplary table storing mapping of caller phone number with landline phone and location in accordance with an embodiment of the present disclosure.

FIG. 6 illustrates exemplary flow of a method for enabling a call routing through a PSTN for a call initiated by a mobile phone in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms as used herein are shown below. To the extent a term used in a claim is not defined below, it should be given the broadest definition persons in the pertinent art have given that term as reflected in printed publications and issued patents at the time of filing.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs. PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”. “can”, “could”, or “might” be included or have a characteristic, that particular component or feature is not required to be included or have the characteristic.

Although, the present disclosure has been described with reference telecommunication calls being initiated from landline phones using mapped mobile phones, it should be appreciated that the same has been done merely to illustrate the disclosure in an exemplary manner and any other purpose or function for which they explained structure or configuration can be used is covered within the scope of the present disclosure.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software.

The present disclosure relates to the field of telecommunication. More particularly, the present disclosure relates to systems and methods for establishing phone calls between a caller and callee.

The present disclosure relates to the field of telecommunication. More particularly, the present disclosure relates to systems and methods for establishing phone calls between a caller and callee.

In an aspect, the present disclosure relates to a system for initiating a call from a landline that is mapped to a caller mobile phone, wherein system includes a call request receipt module configured to, at a first computing device, receive, from the caller mobile phone, a call request comprising a caller identifier and a callee phone number; a landline determination module configured to, at the first computing device, determine the landline based on the received caller identifier; a landline based call initiation module configured to, using the first computing device, initiate a first call to landline number of the determined landline; a callee call initiation module configured to, using the first computing device, initiate a second call to callee phone number, and a callee connection module configured to conference the first call with the second call.

In an aspect, the caller identifier can be any or a combination of a unique identifier of the caller, or caller's mobile number.

In another aspect, the call request can further include any or a combination of a location context of the caller, preferred landline to be used, or selection of a landline from a plurality of landlines stored at the first computing device. In an aspect, the location context of the caller can include any geographical feature. In an aspect, geographical feature can be determined based on any or a combination of NFC (Near-Field Communication), GPS (Global Positioning System), Wi-Fi, radio signals, sound signals, optical signals, and Bluetooth.

In an aspect, the first computing device can be coupled with a database that stores mapping between the caller identifier and the landline. In an aspect, the database can further store mapping between the caller identifier and a plurality of landlines, wherein the landline can be selected from the plurality of landlines based on location contest of the caller or preference defined by the caller. In an aspect, the landline can be mapped with a plurality of caller identifiers.

In another aspect, the caller can be enabled to modify or add or delete or change preference of one or more landlines that map with the caller identifier.

Furthermore, the call request can be initiated from the caller mobile phone to the first computing device by means of any or a combination of a call, an SMS, an application (such as a mobile application), a signal, a data packet, or selection of the callee on a contact directory.

In another aspect, the second call can be initiated before the first call, or both the calls can be initiated simultaneously.

The present disclosure further relates to a method of initiating a call from a landline that is mapped to a caller mobile phone, wherein the method can include the steps of receiving, at a first computing device, from the caller mobile phone, a call request comprising a caller identifier and a callee phone number; determining, at the first computing device, the landline based on the received caller identifier; initiating, using the first computing device, a first call to landline number of the determined landline; initiating, using the first computing device, a second call to calico phone number, and conferencing the first call with the second call.

In an aspect, embodiments of the present disclosure provide a system for initiating an actual call through a wired line (also interchangeably referred to as a PSTN line, or landline phone, or landline phone number, or landline number) based on a call request received at a server from a caller mobile phone (also interchangeably referred to as smart phone, or mobile number, or mobile phone number), wherein the server maps/matches the call request with the landline phone. Though embodiments of the present disclosure have been described with respect to a PSTN, system of present disclosure can be configured to work as an interface between a mobile device and any other fixed line communication network. System of present disclosure can include a server that is configured to receive, from a mobile phone, a call request comprising a caller phone number (also interchangeably referred to as caller ID/identifier or any other unique identifier associated with the caller) and a callee phone number (also interchangeably referred to as callee ID/identifier or any other unique identifier associated with the callee), and process the call request based on the caller phone number/ID to determine a landline phone associated with the caller phone number in order to initiate a call at the determined landline phone through PSTN, and connect the call between the landline phone and the callee's device associated with the callee phone number.

In an aspect, callee phone number can be a landline number or a mobile number, and therefore any embodiment related thereto is well within the scope of the present disclosure. In an instance, caller A can desire to a make a call to callee B, wherein a call request can be sent from the caller A, through his/her mobile phone, to a say a server by sending, as part of the call request, caller phone number (say 981-061-7992) and callee phone number (say 981-029-1328). In an alternate implementation, a unique caller identifier such as AA3456 can be sent as part of the call request by the caller mobile phone instead of the caller phone number per se. Based on such received call request information, server/cloud can determine landline number (say 0120-234-2010) that is mapped to the caller phone number (981-061-7992), and initiate a first call to the mapped landline number (0120-234-2010) and initiate a second call to the callee phone number (981-029-1328), and finally conference the first call and the second call to allow the caller to speak with the callee through his/her mapped/desired landline number.

In an exemplary implementation, server can be configured to receive call request over a wireless interface. Communication between mobile phone/device of caller and server can be enabled through long range wireless communication, for example GSM or other mobile network.

In an exemplary implementation, call request can be initiated as a normal call or as an SMS by the caller, wherein as part of the call request, caller phone number/identifier and callee phone number can be transmitted to the server/cloud (or any other configured computing device). In another exemplary aspect, it may be possible that call request is part of or configured as an independent feature of a specific application (say a mobile app), wherein the call request can be a simple request having say a caller ID (such as AA9823) that can be transmitted from the caller's mobile device/phone and can be mapped to a defined/configured/preferred landline phone, based on which the server can then initiate a call to the landline and another call to the callee phone number so that the calls can be combined.

In an exemplar, implementation, a plurality of landline phones may be associated with a particular caller phone number (which can also be referred interchangeably as caller ID hereinafter). Upon receiving a call request, if the server determines that there are a plurality of landline phones associated with the caller ID/phone number, server can determine location of the mobile phone from where the call request has been received and determine landline phone from the plurality of landline phones to initiate the call.

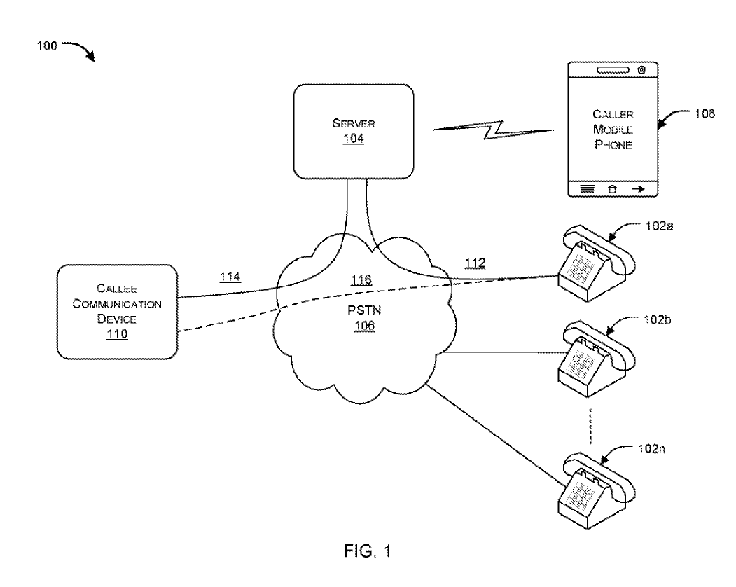

FIG. 1 illustrates an exemplary architecture that can be used for enabling a call initiated on a caller mobile phone 108 to take place over a PSTN line/network 106 in accordance with an embodiment of the present disclosure. As shown in FIG. 1, a server 104 can be configured to receive a call request from a caller mobile phone 108, determine a landline phone 102 that is mapped with the mobile phone 108 based on the received call request, initiate a first call 112 to the determined landline phone (any of 102a, 102b, . . . , 102n) through PSTN, initiate a second call 114 to the callee communication device 110, and connect/conference (shown as 116) the first call 112 with the second call 114 between the determined landline phone 102 and callee communication device 110 associated with the callee phone number.

In an aspect, communication device 110 associated with callee number can be a landline phone (PSTN based) or a mobile phone/device. In an exemplary implementation, server 104 can be a cloud based service or a service managed by a service provider managing the landline phone or a server managed by a third party. In another aspect, server 104 can be a cloud typesetting server that can be diversified as required, and may be an independent server or a centralized server cluster arranged at the same location, or a distributed server cluster including servers arranged at different locations and communicated with each other.

In an aspect user of mobile phone 108 can pre-configure a landline number using which a call can be connected through PSTN. The user can configure different landline numbers for different locations. For example, a user can configure one landline number to be used for initiating the call through PSTN if the calling location of the mobile phone of the user is location X, and another landline number to be used for initiating the call through PSTN if calling location of the mobile phone is location Y. For instance, landline number 0120-2342010 can be used for mobile phone number 9810617992 when user A is in New Delhi, and landline phone number 022-2346778 can be used when for mobile phone number 9810617992 when user A is in Mumbai. Such location of mobile device of user A can be automatically determined, and the server can accordingly initiate the call to the correctly mapped landline number.

In an exemplary implementation, call request from mobile phone 108 can include indication of a preferred landline number 102 (also referred to as landline 102) that should be used to initiate a call through PSTN 106, and a callee number to which the call needs to be connected. Therefore, in an instance, it is possible that a user A, while making a call request to a server, indicates the preferred landline through which he/she would like the call to be initiated to the callee.

In an aspect, mobile phone 108 (including a smart phone or a like computing device such as tablet PC, PDA, among other like devices) can be configured to provide an option to call through PSTN 106, based on which a call request can be accordingly generated by the mobile phone 108. In an exemplary implementation, when making a call request, the mobile phone can enable a user to dial a landline number that is to be used to initiate a call, followed by the callee number. In another implementation, mobile phone 108 can have a pre-stored landline phone number that can be automatically be appended with call request. In another embodiment however, as mentioned above, the server can store a mapping between a mobile phone number and at least one landline phone number, and automatically initiate a call from the mapped landline phone number.

In an exemplary implementation, call request can include a caller ID that is associated with mobile phone 108, and the callee number, wherein, upon receiving such call request, server 104 can determine a landline phone, for example landline phone 102a, landline phone 102b, or landline phone 102n associated with the caller ID, and can cause the determined landline phone to initiate a call through PSTN 106.

In an exemplary implementation, call request can be initiated by a user at the mobile phone 108, wherein callee number can be retrieved from contact list/directory of mobile phone 108. In an exemplary implementation, server 104 can receive callee number from mobile phone 108 over a wireless internet and make a call through PSTN 106. In an embodiment, server 104 can receive call request from mobile device 108 over Internet or any other type/configuration of network, all of which possible implementations are well within the scope of the present disclosure.

As one may appreciate, mobile triggered calling routed using PSTN 106 can result in saving of battery, money and getting clear calling quality during communication while avoiding any radiation concerns, making the technical effect of the present invention clear and evident.

In an aspect, server 104 can also maintain a mapping between callee mobile phone number and a preferred landline number of the callee so that once the server 104 has initiated a first call to the landline number mapped to the caller phone number, server 104 can initiate a second call to the mapped second landline number mapped to the callee mobile phone number so that when the first call and second call are conferenced, both the caller as well as the callee speak with each other through their preferred/mapped landline phone numbers.

In an exemplary implementation, an adaptor (not shown) can be attached between landline phone 102 and wall jack connecting the landline phone 102 with PSTN 106, wherein the adaptor can enable a user to initiate a call over his/her mobile phone 108, and send the call information (such as callee phone number) through sound signals to the adapter, which can then enable dialing of the callee phone number through the landline that it is coupled with directly without the need server to conference in this case. In this embodiment the adapter comprises of a microphone the receive the callee information.

In an aspect, the call request initiated by the caller can include location coordinates of caller's mobile phone, based on which a suitable/mapped landline phone number can be determined to initiate a call there through from the server. Furthermore, the landline preference from the where the caller wishes to initiate the call can be stored on the caller's mobile phone or on the server or on both. Furthermore, the preference may be switched using various location contexts of the caller. Furthermore, the preference may be switched based on context of the caller, which can include GPS location, NFC, Bluetooth, radio signals, Wi-Fi signals, optical signals, and sound signals, or any other geographical feature received on any) suitable sensor configured in the mobile phone.

It is also possible that the caller explicitly, in the call request, mentions the preferred landline number that he/she would like to use to initiate the call through the server. For instance, in a first aspect, mobile phone of user A can be mapped with 0120-2342010 at the server and such mapping can be stored in the server itself, wherein in a second aspect, mobile phone can be mapped with 0120-2342011 at the caller's mobile phone and such mapping can be stored in the caller mobile phone itself, and in a third aspect, the caller can, as part of the call request, explicitly mention the preferred landline number 0120-2342012, which can be used by the server to initiate a call to this landline number. Any other possible implementation relating to determination of landline phone number that is to be used for initiating a call to a callee is well within the scope of the present disclosure.

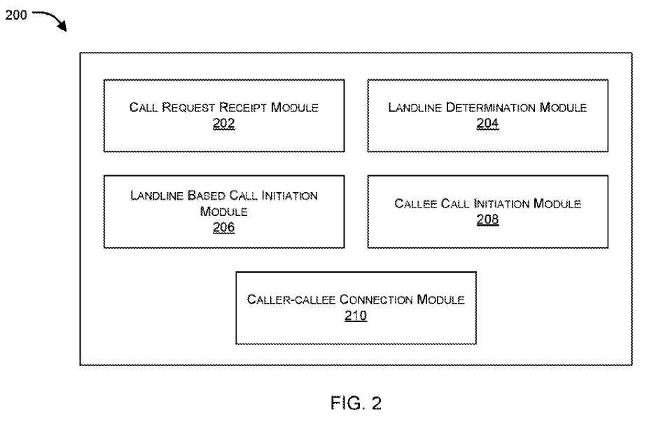

FIG. 2 illustrates exemplary functional modules of a system for enabling call initiated by a mobile phone to take place over a PSTN in accordance with an embodiment of the present disclosure. In an aspect, the present disclosure relates to a system 200 for initiating a call from a landline that is mapped to a caller mobile phone, wherein system 200 can include a call request receipt module 202 configured to, at a first computing device, receive, from the caller mobile phone, a call request comprising a caller identifier and a callee phone number. System 200 can further include a landline determination module 204 configured to, at the first computing device, determine the landline based on the received caller identifier. System 200 can further include a landline based call initiation module 206 configured to, using the first computing device, initiate a first call to landline number of the determined landline; a callee call initiation module 208 configured to, using the first computing device, initiate a second call to callee phone number; and a caller-callee connection module 210 configured to conference the first call with the second call.

In an aspect the caller identifier can be any or a combination of a unique identifier of the caller or caller's mobile number. In another aspect the call request can further include any or a combination of a location context of the caller, preferred landline to be used, or selection of a landline from a plurality of landlines stored at the first computing device. In an aspect the location context of the caller can include geographical features determined based on any or a combination of NFC, GPS, Wi-Fi, radio signals, sound signals, optical signals, and Bluetooth.

In an aspect the first computing device can be coupled with a database that stores mapping between the caller identifier and the landline. The first computing device can be coupled with a database that stores mapping between the caller identifier and a plurality of landlines, wherein the landline is selected from the plurality of landlines based on location context of the caller or preference defined by the caller.

In an aspect, the landline can be mapped with a plurality of caller identifiers associated with one or more users/callers. In yet another aspect, the caller can be enabled to modify or add or delete or change preference of one or more landlines that map with the caller identifier.

Furthermore, call request can be initiated from the caller mobile phone to the first computing device by means of any or a combination of a call, an SMS, an application, a signal, a data packet, or selection of the callee on a contact directory.

In another aspect, the second call can be initiated before the first call, or the first call can be simultaneously initiated with the second call.

In an aspect, the proposed system 200 can further include a landline association module (not shown) to enable a user to associate at-least one landline phone that can be used to initiate a call through PSTN.

In another aspect, call request receipt module 202 can be configured to receive, at a server/cloud/computing device, a call request comprising a caller ID and callee number from a mobile phone to connect a call through PSTN. Based on such caller ID, landline phone number mapping with the caller ID can be determined, and a first call can be made to the determined landline phone number, post or along with which a second call be made to the callee phone number to finally connect/conference the first call with the second call. Any standard computer telephony integration technology (not shown) could be used to manage the call initiation and the conferencing at the server.

In an exemplary implementation, a user can be allowed to, for a particular mobile phone number/mobile device, pre-associate different landline phones/numbers for different locations. In an exemplary implementation, a default landline phone can be associated with a caller ID or a mobile phone. In an aspect, a logical/physical association table maintaining association of caller ID with different landline phones can be maintained by a server. The mobile phone can be configured to enable a user to select an option of calling through PSTN or calling directly through mobile network. In an exemplary implementation, the proposed system can enable a user to associate a landline phone at run time while triggering the call request. The user can associate a landline phone by dialing a landline phone number before dialing the callee number. In an instance, prefix and suffix can be used by the user to indicate the landline phone to be used. For example, a user can associate a landline number by dialing *01201234567# followed by the callee number. If there is no landline phone associated with the mobile phone of the user, dialed landline number can be used and association table (maintaining caller ID and landline phone mapping) can be updated at the server.

In an aspect, upon receiving call request, system of the present disclosure can process the call request to determine the landline phone that can be used to initiate the call, and further determine authenticity of the mobile phone issue such call requests. In an exemplary implementation, the proposed system can determine or select a landline phone from a plurality of pre-configured landline phones based on location of the mobile device. In an exemplary implementation, status of the pre-configured landline phones can be checked in real-time, and a suitable landline phone based on availability (i.e. to select a landline phone that is not busy) can be selected/identified for initiation of the first call. While determining the landline phone to be used, the proposed system can further incorporate parameters such as calling rate of each pre-configured landline phone into consideration, wherein the server can maintain list of authorized mobile phones by storing unique physical ID or caller ID of each authorized mobile phone. In an exemplary implementation, when call request includes identification of landline phone, the proposed system can check rights/authenticity of the mobile phone/device to connect through given landline phone.

Though some embodiments have been described with respect of outgoing calls, one may appreciate that server of present disclosure can be configured to receive and process incoming call as well by, for instance, automatically initiating the second call to the landline phone number mapped to the callee mobile phone number in cases when the callee phone number dialed by the caller is a mobile number.

In an aspect, location context change can automatically switch the preferred landline associated with the caller mobile phone. For instance, when a user/caller enter his/her home and senses a specific MAC address of a Wi-Fi device, it may trigger the mobile phone to send a preferred landline change request to the server/cloud so that subsequent calls are automatically dialed using the preferred landline.

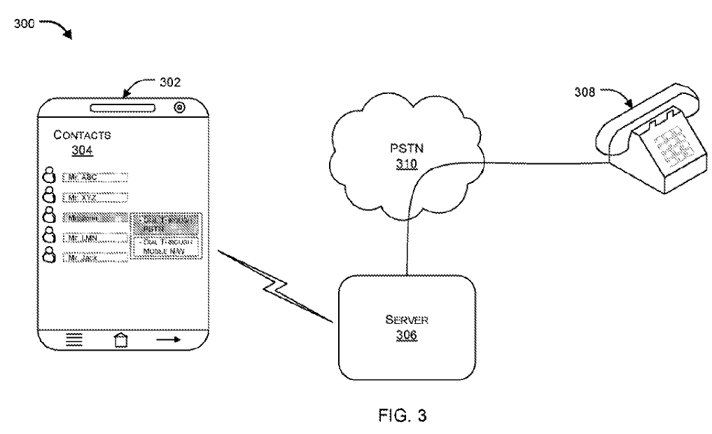

FIG. 3 illustrates an exemplary network set-up for enabling call initiated by a mobile phone to take place over a PSTN in accordance with an embodiment of the present disclosure. As shown in FIG. 3, a mobile phone 302 can be configured to enable a user to select a network through which he/she wishes to dial a callee number. Mobile phone 302 can be configured to provide such option by a software upgrade, for instance. In an exemplary implementation, mobile phone 302 can enable a user to either dial a callee number using the keypad of the phone 302, or in a preferred implementation, can enable the user to browse the contact/phone list/directory 304 of the phone 302 in order to retrieve the desired callee contact information/number.

In an exemplary implementation, user can either select to dial through PSTN (mapped/preferred landline), or dial through mobile network (i.e. through the mobile phone 302 itself). When the user selects to dial through PSTN, a call request, which may include a caller ID and/or caller phone number, and callee phone number, can be transmitted from the mobile phone 302 to server 306, which processes the call request with reference to a mapping table (stored say in a database that the server is coupled with or stores) to identify a landline phone that is mapped with the caller ID and/or caller phone number. The server 306 can then initiate a first call to the landline phone 308, and initiate a second call to the callee phone number (not shown), and finally connect/conference the first call with the second call through the PSTN 310 that the landline device 308 is connected to.

In an aspect, server 306 can perform format conversion to enable data, for example call request, voice call data etc. to be converted from PSTN format to format of suitable wireless communication medium, and vice-versa.

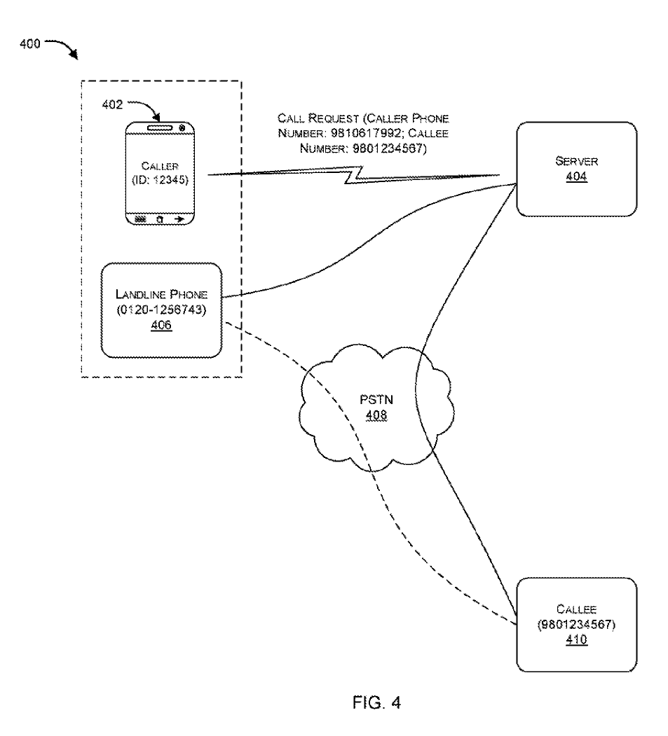

FIG. 4 illustrates an exemplary call routing through a landline phone for a call initiated by a mobile phone in accordance with an embodiment of the present disclosure. As shown in FIG. 4, a call request initiated by mobile phone 402 can include a caller mobile phone number (for instance, 9810617992) and a callee phone number (for instance, 9801234567), which request can be sent to server 404. In an aspect, the call request can be an actual call by the caller to the callee, wherein the call, instead of being routed to the callee, can be routed to the configured server 404.

Upon receipt of call request information from caller mobile phone 402, server 404, can determine mapping between the caller phone number 402 and a landline number 406 (for instance, 0120-1256743). Based on such mapping, a first call can be initiated by the server 404 to the landline 406 through a PSTN network 408, and a second call can be initiated by the server 404 to the callee phone number 410 (9801234567). The first call and the second call can then be connected with each other so that the user can use the desired/mapped landline phone 406 to connect and speak with the callee phone number 410.

In an exemplary implementation, mobile phone 402 can be configured to show status of landline phone 406, wherein the status can indicate if landline phone 406 is busy or free or having any trouble. Server 404 of present disclosure can be configured to include caller phone number when establishing the call so as to enable the callee to read the caller ID. Various status messages can be shown to the user on mobile phone 402 while the call is in progress using a customer relationship management (CRM) system. In an exemplary implementation, instead of dialing a number or selecting a number from contact list, user of the mobile phone 402 can make a call request for a callee number from whom a missed call on a mobile phone 402 may have been received. In an exemplary implementation, the server 404 can include features of a computer telephony integration (CTI) to enable such PSTN based calls.

In an exemplary implementation, functionality of server of present disclosure can be implemented in an adaptor, which can be connected between a landline phone and a PSTN line, wherein the adaptor can be configured to receive call request (in the form of say an actual call) from a mobile device in the form of a sound signal, and process the received sound signal to transmit the callee number to which the connected landline is to initiate a call connection with through PSTN.

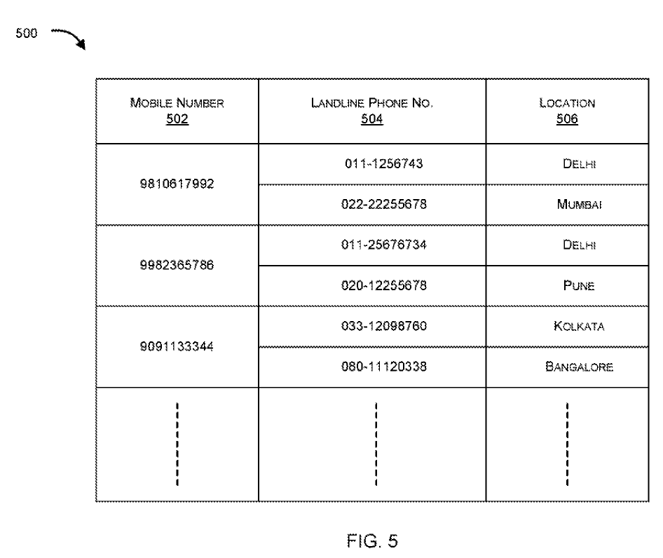

FIG. 5 illustrates an exemplary table storing mapping of caller phone number with landline phone and location in accordance with an embodiment of the present disclosure. As shown in FIG. 5, table 500 can include fields such as caller phone number 502, landline phone number 504, and location 506, wherein the table 500 can be maintained at a server and used to determine a landline phone number to be used to initiate a call. For a particular caller phone number, there may be one or more landline phone numbers associated. In an exemplary implementation, for a caller phone number, a landline phone number can be mapped along with location of mobile phone associated with the caller phone number. Mapping of caller phone number 502 with landline phone number 504 and location 506 enables the proposed server to determine a suitable landline number based on location of mobile phone when call request is initiated. For example, a caller phone number 9810617992 can be associated with landline 0120-1256743 and 022-22255678, wherein the server can use 0120-1256743 to initiate the call when the mobile phone (associated with caller phone number 9810617992) is determined to be located in Delhi. and use 022-22255678 to initiate the call when the mobile phone (associated with caller phone number 9810617992) is determined to be located in Mumbai.

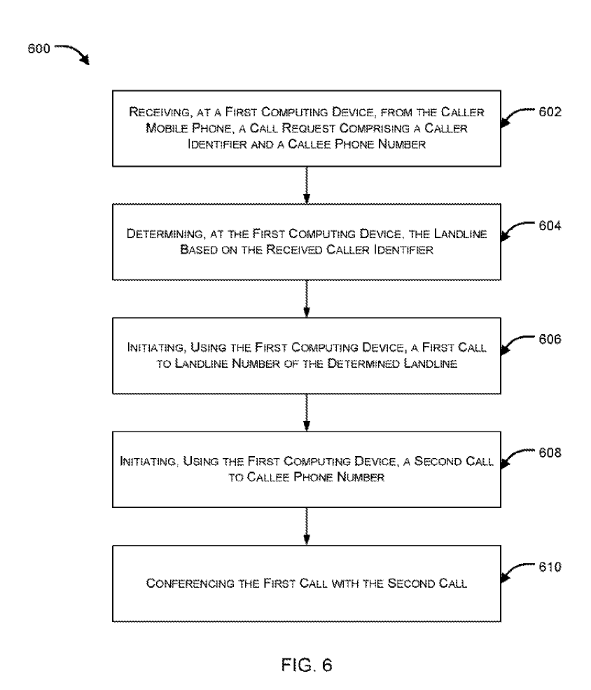

FIG. 6 illustrates exemplary flow of a method for enabling a call routing through a PSTN for a call initiated by a mobile phone in accordance with an embodiment of the present disclosure. In an aspect, the method for initiating a call from a landline that is mapped to a caller mobile phone can include the steps of, at 602, receiving, at a first computing device, from the caller mobile phone, a call request comprising a caller identifier and a callee phone number, at 604, determining, at the first computing device, the landline based on the received caller identifier, at 606, initiating, using the first computing device, a first call to landline number of the determined landline; at 608, initiating, using the first computing device, a second call to callee phone number, and at 610, conferencing the first call with the second call.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF INVENTION

The present invention provides a server/cloud based service that enables mapping of landline phone numbers with mobile phone numbers such that calls initiated from mobile phones can be dialed through mapped landline phone numbers.

The present invention provides a system and a method that can enable call through PSTN line by dialing a number saved in contact list of a mobile phone.

The present invention provides a method for enabling routing of call initiated by a mobile phone through PSTN thereby saving of battery, money and getting clear calling quality during communication while avoiding any radiation concerns.

The present invention provides an adaptor that is configured between PSTN line and a landline phone, wherein the adapter can receive sound signals from a mobile phone when the mobile phone dials a callee, and can forward the callee number received in the sound signals to the landline phone such that the landline phone can initiate the call.

1. A system for initiating a call from a landline that is mapped to a caller mobile phone, said system comprising:
a call request receipt module configured to, at a first computing device, receive, from the caller mobile phone, a call request comprising a caller identifier and a callee phone number,
a landline determination module configured to, at the first computing device, determine the landline based on the received caller identifier;
a landline based call initiation module configured to, using the first computing device, initiate a first call to landline number of the determined landline;
a callee call initiation module configured to, using the first computing device, initiate a second call to callee phone number, and
a callee connection module configured to conference the first call with the second call.

2. The system of claim 1, wherein the caller identifier is any or a combination of a unique identifier of the caller or caller's mobile number.

3. The system of claim 1, wherein the call request further comprises any or a combination of a location context of the caller, preferred landline to be used, or selection of a landline from a plurality of landlines stored at the first computing device.

4. The system of claim 3, wherein the location context of the caller comprises geographical features determined based on any or a combination of NFC, GPS, Wi-Fi, radio signals, sound signals, optical signals, and Bluetooth.

5. The system of claim 1, wherein the first computing device is coupled with a database that stores mapping between the caller identifier and the landline.

6. The system of claim 1, wherein the first computing device is coupled with a database that stores mapping between the caller identifier and a plurality of landlines, wherein the landline is selected from the plurality of landlines based on location context of the caller or preference defined by the caller.

7. The system of claim 1, wherein the landline is mapped with a plurality of caller identifiers.

8. The system of claim 1, wherein the caller is enabled to modify or add or delete or change preference of one or more landlines that map with the caller identifier.

9. The system of claim 1, wherein the call request is initiated from the caller mobile phone to the first computing device by means of any or a combination of a call, an SMS, an application, a signal, a data packet, or selection of the callee on a contact directory.

10. The system of claim 1, wherein the second call is initiated before the first call or the first call is simultaneously initiated with the second call.

11. A method for initiating a call from a landline that is mapped to a caller mobile phone, said method comprising the steps of:
receiving, at a first computing device, from the caller mobile phone, a call request comprising a caller identifier and a callee phone number;
determining, at the first computing device, the landline based on the received caller identifier;
initiating, using the first computing device, a first call to landline number of the determined landline;
initiating, using the first computing device, a second call to callee phone number; and
conferencing the first call with the second call.

12. The method of claim 11, wherein the caller identifier is any or a combination of a unique identifier of the caller or caller's mobile number.

13. The method of claim 11, wherein the call request further comprises any or a combination of a location context of the caller, preferred landline to be used, or selection of a landline from a plurality of landlines stored at the first computing device.

14. The method of claim 14, wherein the location context of the caller comprises geographical features determined based on any or a combination of NFC, GPS, Wi-Fi, radio signals, sound signals, optical signals, and Bluetooth.

15. The method of claim 11, wherein the first computing device is coupled with a database that stores mapping between the caller identifier and the landline.

16. The method of claim 11, wherein the first computing device is coupled with a database that stores mapping between the caller identifier and a plurality of landlines, wherein the landline is selected from the plurality of landlines based on location context of the caller or preference defined by the caller.

17. The method of claim 11, wherein the landline is mapped with a plurality of caller identifiers.

18. The method of claim 11, wherein the caller is enabled to modify or add or delete or change preference of one or more landlines that map with the caller identifier.

19. The method of claim 11, wherein the call request is initiated from the caller mobile phone to the first computing device by means of any or a combination of a call, an SMS, an application, a signal, a data packet, or selection of the callee on a contact directory.

20. The method of claim 11, wherein the second call is initiated before the first call or the first call is simultaneously initiated with the second call.
